(19) United States
(12) Patent Application Publication
(10) Pub. No.: US 2023/0393319 A1
(43) Pub. Date: Dec. 7, 2023

(54) POLARIZING GLASS AND OPTICAL ISOLATOR

(71) Applicant: HOYA CORPORATION, Tokyo (JP)

(72) Inventor: Yoshitaka YONEDA, Tokyo (JP)

(73) Assignee: HOYA CORPORATION, Tokyo (JP)

(21) Appl. No.: 18/234,473

(22) Filed: Aug. 16, 2023

Related U.S. Application Data
(63) Continuation of application No. PCT/JP2022/006197, filed on Feb. 16, 2022.

(30) Foreign Application Priority Data
Feb. 21, 2021 (JP) 2021-025770

(51) Int. Cl. G02B 5/30

(52) U.S. Cl. CPC G02B 5/3058

(57) ABSTRACT

The present invention provides a polarizing glass with better heat resistance than a conventional polarizing glass and an optical isolator including the polarizing glass. In the polarizing glass, metal layers in which many substantially needle-shaped metal fine particles are dispersed to be oriented parallel to one another are formed from both surfaces toward inside and a metal halide layer containing metal halide fine particles is formed between the metal layers. A total thickness of the polarizing glass is smaller than 0.12 mm, a thickness of each of the metal layers is 0.030 to 0.045 mm, and a thickness of the metal halide layer is 0.001 to 0.040 mm. Alternatively, the total thickness of the polarizing glass is smaller than 0.12 mm, the thickness of each of the metal layers is 0.010 to 0.030 mm, and the thickness of the metal halide layer is 0.001 to 0.060 mm.

### TECHNICAL FIELD

The present disclosure relates to subject matter contained in Japanese Patent Application No. 2021-025770 (filed on Feb. 21, 2021) which is expressly incorporated herein by reference in its entirety.

The present invention relates to a polarizing glass used in optical parts such as an optical isolator, and particularly relates to a polarizing glass with high heat resistance and an optical isolator including the polarizing glass.

### BACKGROUND ART

A polarizing glass in which needle-shaped metal fine particles made of silver or copper are dispersed in a glass substrate such that longitudinal directions of the particles are oriented in a specific direction has been conventionally used as a polarizing element of an optical isolator. It is well known that such a polarizing glass can be fabricated by reducing a drawn glass containing copper halide particles or a drawn glass containing silver halide particles. For example, Patent Literature 1 discloses a method of fabricating the polarizing glass from the glass containing copper halide particles in the following steps.

(1) A glass material containing cuprous chloride is prepared to have a desired composition, is melted at about 1450° C., and then slowly cooled to room temperature.

(2) The glass material is then subjected to heat treatment to deposit fine particles of cuprous chloride in the glass.

(3) After the deposition of the fine particles of cuprous chloride, a preform having a suitable shape is fabricated by machining.

(4) The preform is drawn under a predetermined condition to obtain needle-shaped fine particles of cuprous chloride.

(5) Needle-shaped metal copper fine particles are obtained by reducing the drawn glass in a hydrogen atmosphere.

Among such polarizing glasses, a polarizing glass with a thickness of 0.20 mm has been conventionally mainly used and, as thin polarizing glasses, polarizing glasses with thicknesses of 0.15 mm and 0.12 mm have been put to practical use. However, due to demands for reducing the size of the optical isolator, an even thinner polarizing glass is in demand.

Moreover, in recent years, high-energy laser light is used at a higher frequency with an increase in communication speed in the field of optical communication. Accordingly, there has occurred a problem of heat tending to be accumulated in the optical isolator, and a polarizing glass with high heat resistance is in demand also as the polarizing glass used in the optical isolator.

### CITATION LIST

### Patent Literature

Patent Literature 1: Japanese Patent Application Publication No. Hei 5-208844

### SUMMARY

### Technical Problem

FIG. 4 is a diagram illustrating results of testing heat resistance of polarizing glasses manufactured in the method described in Patent Literature 1. In FIG. 4, each of generally-used conventional polarizing glasses that have thicknesses of 0.20, 0.15, and 0.12 mm and in which the thickness of each of metal layers (reduced layers) formed from both surfaces of each glass toward inside is 0.038 mm is subjected to heat treatment for two hours at each of temperatures of 420° C., 440° C., and 460° C., and extinction ratios at a measurement wavelength of 1650 nm before and after the heat treatment are compared.

As illustrated in FIG. 4, the extinction ratio of the conventional polarizing glass with the thickness of 0.20 mm decreased by 1.57 dB at 420° C., by 2.36 dB at 440° C., and by 6.32 dB at 460° C. Moreover, the extinction ratio of the conventional polarizing glass with the thickness of 0.15 mm decreased by 0.36 dB at 420° C., by 0.14 dB at 440° C., and by 4.22 dB at 460° C. Furthermore, the extinction ratio of the conventional polarizing glass with the thickness of 0.12 mm decreased by 0.32 dB at 420° C., by 0.19 dB at 440° C., and by 3.21 dB at 460° C.

The present invention has been made in view of the circumstances described above. Some embodiments provide a polarizing glass having excellent heat resistance while being thinner than a conventional polarizing glass and an optical isolator including this polarizing glass.

### Solution to Problem

The present inventor made earnest studies to achieve the aforementioned object and found that reducing a thickness of a polarizing glass itself and also reducing a thickness of an unreduced layer (metal halide layer) present between metal layers formed on both sides by a reduction step enables obtaining of a polarizing glass with excellent heat resistance while suppressing a decrease of an extinction ratio. The present invention has been made based on such a finding.

Specifically, a polarizing glass of one embodiment is a polarizing glass in which metal layers are formed from both surfaces toward inside and a metal halide layer containing metal halide fine particles is formed between the metal layers, the metal layers being layers in which many substantially needle-shaped metal fine particles are dispersed to be oriented parallel to one another, in which a total thickness of the polarizing glass is smaller than 0.12 mm, a thickness of each of the metal layers is 0.030 to 0.045 mm, and a thickness of the metal halide layer is 0.001 to 0.040 mm.

From another aspect, a polarizing glass of another embodiment is a polarizing glass in which metal layers are formed from both surfaces toward inside and a metal halide layer containing metal halide fine particles is formed between the metal layers, the metal layers being layers in which many substantially needle-shaped metal fine particles are dispersed to be oriented parallel to one another, in which a total thickness of the polarizing glass is smaller than 0.12 mm, a thickness of each of the metal layers is 0.010 to 0.030 mm, and a thickness of the metal halide layer is 0.001 to 0.060 mm.

The metal fine particles may be copper or silver fine particles.

From still another aspect, an optical isolator of another embodiment is an optical isolator including any one of the above polarizing glass.

According to some embodiments, a polarizing glass having excellent heat resistance while being thinner than a conventional polarizing glass is achieved. In addition, an optical isolator including this polarizing glass is achieved.

### BRIEF DESCRIPTION OF DRAWINGS

FIGS. 1A and 1B are schematic diagrams explaining a structure of a polarizing glass according to an embodiment described herein.

FIG. 2 is an outline side cross-sectional diagram schematically illustrating a configuration of an optical isolator using the polarizing glass according to the embodiment described herein and an optical system around the optical isolator.

FIG. 3 is digital microscope photographs illustrating cross-sections of the polarizing glasses (Example 1) according to the embodiment described herein.

FIG. 4 is a diagram illustrating results of testing heat resistance of polarizing glasses manufactured in a method described in a conventional technique.

### DESCRIPTION OF EMBODIMENT

Some embodiments of the present invention will be described below in detail with reference to the drawings. Note that the same or corresponding portions in the drawings are denoted by the same reference numerals, and description thereof is not repeated.

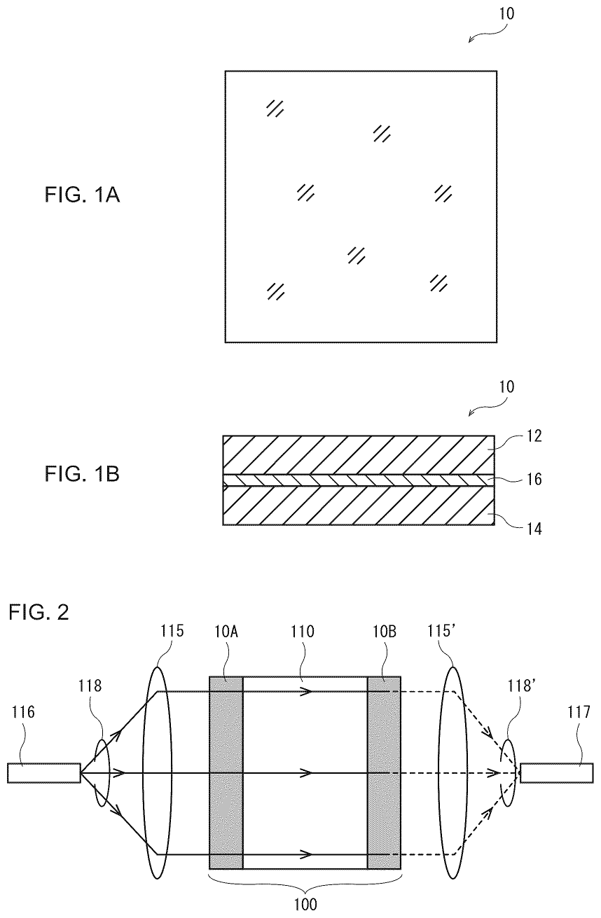

FIG. 1 is a schematic diagram explaining a structure of a polarizing glass 10 according to the embodiment described herein, FIG. TA is a plan diagram, and FIG. 1B is a side cross-section diagram. Moreover, FIG. 2 is an outline side cross-sectional diagram schematically illustrating a configuration of an optical isolator 100 using the polarizing glass 10 of the present embodiment and an optical system around the optical isolator 100. As illustrated in FIGS. 1 and 2, the polarizing glass 10 (in FIG. 2, illustrated as polarizing elements 10A and 10B) of the present embodiment is a polarizing element attached to both faces of a Faraday rotator 110 of the optical isolator 100, and is an optical element in which needle-shaped metal fine particles made of silver or copper are dispersed in a glass substrate such that longitudinal directions of the needle-shaped metal fine particles are oriented in a specific direction.

As illustrated in FIG. 2, the optical system around the optical isolator 100 of the present embodiment includes lenses 115, 115′, an optical fiber 116, a light source 117 such as a semiconductor laser, and the like with the optical isolator 100 at the center. In FIG. 2, 118, 118′ schematically illustrate light beams of return light returning toward the light source 117, the light beam 118 indicates reflection light or the like reflected on an end face of the optical fiber 116, and the light beam 118′ indicates a light beam after transmission through the polarizing element 10B. In the optical isolator 100 illustrated in FIG. 2, polarizing transmission axes of the polarizing elements 10A and 10B are arranged to form an angle of 45 degrees with each other, and an optical path length of the Faraday rotator 110 is set such that a polarizing plane rotation angle in the Faraday rotator 110 is 45 degrees. A light beam (not illustrated) emitted from the light source 117 is converted to a parallel light beam by the lens 115′, and only the light having polarizing in a direction parallel to the polarizing transmission axis of the polarizing element 10B enters the Faraday rotator 110. The polarizing direction of the light having entered the Faraday rotator 110 is rotated by 45 degrees by the Faraday effect generated by a permanent magnet (not illustrated). As described above, since the polarizing transmission axes of the polarizing elements 10A and 10B form an angle of 45 degrees with each other, a polarizing direction of light having transmitted through the Faraday rotator 110 matches the polarizing transmission axis of the polarizing element 10A. Accordingly, the light transmitted through the Faraday rotator 110 is transmitted through the polarizing element 10A with almost no loss, and enters the optical fiber 116 by being condensed by the lens 115.

The return light beam 118 returning toward the light source by being reflected on the end face of the optical fiber 116 or an optical element or the like (not illustrated) arranged in a stage after the optical fiber 116 returns to the light source 117 through an optical path opposite to that of the aforementioned light beam emitted from the light source 117. In this case, due to non-reciprocity of the Faraday rotator 110, a polarizing direction of the return light beam 118 after the transmission through the Faraday rotator 110 forms an angle of 90 degrees with the polarizing transmission axis of the polarizing element 10B. Accordingly, in the transmission through the polarizing element 10B, optical energy of the return light beam 118 is greatly lost (that is, the return light 118 can be blocked).

Using the optical isolator 100 in which the polarizing glasses 10 are provided on both faces of the Faraday rotator 110 as described above can block the return light 118′ returning toward the light source 117.

As illustrated in FIG. 1, the polarizing glass 10 of the present embodiment has a rectangular plate shaped (for example, 11 mm (lateral direction)×11 mm (vertical direction), thickness of 0.02 to 0.11 mm) exterior. Metal layers 12 and 14 in which many substantially needle-shaped metal fine particles are dispersed to be oriented parallel to one another are formed on both surfaces of the polarizing glass 10 on the front side and the back side, and a metal halide layer (unreduced layer) 16 containing metal halide fine particles is formed between the metal layers 12 and 14 (FIG. 1B).

The metal layers 12 and 14 are each a layer that is formed by a reduction step to be described later by deposition of the needle-shaped metal fine particles made of silver or copper and that has a predetermined thickness (for example, 0.010 to 0.045 mm).

Moreover, the metal halide layer 16 is a layer that is formed in an interior by the formation of the metal layers 12 and 14 by the reduction step to be described later and that has a predetermined thickness (for example, 0.001 to 0.060 mm).

### [Manufacturing Method of Polarization Glass 10]

The polarizing glass 10 of the present embodiment is manufactured in the following steps.

(1) A glass material containing copper or silver is prepared to have a desired composition, is melted at about 1450° C., and then slowly cooled to room temperature (manufacturing step of the glass substrate).

(2) The glass substrate is subjected to heat treatment to deposit fine particles of cuprous chloride or silver chloride in the glass (deposition step of the metal halide fine particles).

(3) A preform having a suitable shape is fabricated by machining (preform fabrication step).

(4) The preform is heated and drawn under a predetermined condition to obtain a glass sheet (drawing step of glass).

(5) The glass sheet is cut and polished on both sides to fabricate a both-side polished product (polished product fabrication step).

(6) The polished product is reduced in a hydrogen atmosphere to deposit the needle-shaped metal (copper or silver) fine particles, and the metal layers 12 and 14 and the metal halide layer 16 are formed (reduction step).

### [Glass Substrate]

Note that the glass substrate of the polarizing glass 10 in the present embodiment is a glass selected from a group consisting of silicate glass, borate glass, and borosilicate glass, and a specific raw-material composition in the case of depositing the copper fine particle is preferably a composition containing at least one additive component selected from the group consisting of Y₂O₃, La₂O₃, V₂O₅, Ta₂O₅, WO₃, and Nb₂O₅ in a composition of
SiO₂: 48 to 65,
B₂O₃: 13 to 33,
Al₂O₃: 6 to 13,
AlF₃: 0 to 5,
alkali metal oxide: 7 to 17,
alkali metal chloride: 0 to 5,
alkali earth metal oxide: 0 to 5,
copper oxide and copper halide: 0.3 to 2.5,
SnO: 0 to 0.6, and
As₂O₃: 0 to 5
   in terms of wt %.

Moreover, in this case, the content of the selected additive component per type is preferably in a range of 0.05 to 4% in terms of mol %, the total content in the case where multiple types of additive components are selected is preferably 6% or less in terms of mol %, and Cl contained in the glass substrate is preferably 0.47 to 0.58 wt % with respect to the entire glass substrate in terms of wt %.

Moreover, a specific raw-material composition in the case of depositing the silver fine particles is preferably a composition containing at least
Ag: 0.15 to 1.0%, and
Cl and/or Br: chemical equivalent of Ag or more in a composition 100 wt % substantially composed of
SiO₂: 50 to 65%,
B₂O₃: 15 to 22%,
Al₂O₃: 0 to 4%,
ZrO₂: 2 to 8%,
6%<Al₂O₃+ZrO₂<12%,
R₂O: 6 to 16% (Note that R is at least one of Li, Na, and K)
Li₂O: 0 to 3%,
Na₂O: 0 to 9%,
K₂O: 4 to 16%,
Li₂O+Na₂O<K₂O,
BaO and/or SrO: 0-7%, and
TiO₂: 0 to 3%.

In the polarizing glass 10 manufactured in the manufacturing step as described above, the needle-shaped metal fine particles are basically present only near the surfaces (that is in the metal layers 12 and 14) of the polarizing glass 10, and a range of each of such regions from the glass surfaces (that is the thickness of each of the metal layers 12 and 14) depends on conditions of the reduction step such as atmosphere temperature, time exposed to a reduction atmosphere, and the like. In other words, controlling the conditions of the reduction step enables control of the thicknesses of the metal layers 12 and 14, and also enables control of the thickness of the metal halide layer 16 formed between the metal layers 12 and 14.

Here, the present inventor earnestly studied the heat resistance of the polarizing glass 10 and found the following facts. Although the glass transition temperature Tg of the polarizing glass 10 is about 500° C., in the cases of thicknesses of 0.20, 0.15, and 0.12 mm (that is in the case of the conventional polarizing glass) as described above, the extinction ratio decreases (that is the polarizing characteristic degrades) at 500° C. or lower, and the thicker of the polarizing glass is, the more notable the amount of this decrease is (FIG. 4).

The decrease of the extinction ratio can be assumed to be due to the following reason. Since the melting points of the metal halides CuCl, AgCl, and AgBr in a polarizing glass interior are 430° C., 455° C., and 434° C., respectively, when the polarizing glass 10 is exposed to high temperature of 430 to 455° C., the needle-shaped metal halides in the metal halide layer 16 are liquified, and internal strain in the metal layers 12 and 14 present near the metal halide layer 16 is reduced. As a result, the shape of the drawn needle shape becomes blunt, the shape of the needle-shaped metal fine particles becomes blunt, and the aspect ratio (horizontal to vertical ratio) of this shape decreases. As a result, the extinction ratio decreases.

Moreover, the decrease of the extinction ratio can be assumed to be due to the following reason. After completion of the heat treatment, heat of solidification released when the liquified metal halides are solidified similarly reduces the internal strain in the metal layers 12 and 14 near the metal halide layer 16, the shape of the drawn needle shape becomes blunt, the shape of the needle-shaped metal fine particles becomes blunt, and the aspect ratio (horizontal to vertical ratio) of this shape decreases. As a result, the extinction ratio decreases.

Accordingly, in the present embodiment, the total thickness of the polarizing glass 10 is reduced to control (that is to reduce) the thickness of the metal halide layer 16. The effects of liquification and solidification of the metal halides are thus reduced, and the heat resistance of the polarizing glass 10 is improved.

Note that an extinction characteristic of the polarizing glass 10 generally varies depending on the density and the size of the needle-shaped metal fine particles and the thicknesses of the metal layers 12 and 14, in addition to the aspect ratio (horizontal to vertical ratio) of the needle-shaped metal fine particles. Meanwhile, an insertion loss characteristic is poor when the needle-shaped metal fine particles are too large or the thicknesses of the metal layers 12 and 14 are too large. These parameters each have a suitable range depending on the composition of the polarizing glass 10, and are each designed within the suitable range as appropriate (details are described later).

Another method for reducing the thickness of the metal halide layer 16 is increasing the thicknesses of the metal layers 12 and 14 without changing the total thickness of the polarizing glass 10. However, this method has the following problem. Increasing the thicknesses of the metal layers 12 and 14 takes time (that is the reduction step takes time), and the cost increases.

A distance L of diffusion of hydrogen from the surface of the polarizing glass 10 is generally expressed by the following formula (1).

L=2(Dt)^{1/2} . . . (1) In this formula, D is a diffusion coefficient and t is time.

Since the diffusion distance L is proportional to a square root of the time t, four times of reduction time is required to double the thicknesses of the metal layers 12 and 14.

Moreover, in the polarizing glass that is created as described above and in which the metal layers 12 and 14 are relatively thick, observation of a boundary between the metal halide layer 16 and each of the metal layers 12 and 14 is difficult.

The present inventor made earnest studies and found the following facts. When the thickness of each of the metal layers 12 and 14 is 0.045 mm or smaller, the boundary between the metal halide layer 16 and each of the metal layers 12 and 14 can be clearly observed with an optical microscope or a digital microscope (for example, digital microscope VHX series manufactured by Keyence Corporation), and each of the thicknesses can be measured at measurement accuracy of ±0.002 mm or smaller. However, when the thickness of each of the metal layers 12 and 14 exceeds 0.045 mm, the boundary between the metal halide layer 16 and each of the metal layers 12 and 14 is unclear, and a measurement error of 0.005 mm or larger occurs.

Moreover, when the reduction time is long and the thickness of each of the metal layers 12 and 14 exceeds 0.045 mm as described above, there is a risk that many incompletely-reduced portions, that is metal halides remain in the reduced metal layers 12 and 14. Then, when such a polarizing glass 10 is subjected to a heat resistance test (that is heated), the metal halides remaining in the metal layers 12 and 14 reduce the internal strain by being liquified and by releasing heat of solidification in solidification in cooling, and makes the shape of the needle-shaped metal fine particles blunt. As a result, the aspect ratio of the metal fine particles decreases and a problem of a decrease of the extinction ratio occurs.

Moreover, when such metal halides are present in the interiors of the metal layers 12 and 14, the needle-shaped metal fine particles to be affected are present at closer locations. Accordingly, a decrease of the extinction ratio is assumed to be greater. Then, in such a case, the heat resistance is assumed to be not improved as much in proportion to the increase in the thicknesses of the metal layers 12 and 14 and the decrease in the thickness of the metal halide layer 16.

Moreover, in a polarizing glass in which the thickness of each of the metal layers 12 and 14 is 0.010 mm or smaller, the thickness of each of the metal layers 12 and 14 that provide the polarizing characteristic is too small, and a sufficient extinction ratio cannot be obtained.

Furthermore, the present inventor made earnest studies and found that, in the polarizing glass 10 in which the thickness of each of the metal layers 12 and 14 is 0.009 mm or smaller, the extinction ratio is about 25 dB and is too low, and this polarizing glass 10 is not suitable for an optical isolator.

As described above, in the present embodiment, the thickness of the metal halide layer 16 is reduced by setting the thickness of each of the metal layers 12 and 14 to 0.010 to 0.045 mm and by reducing the total thickness of the polarizing glass 10. The effects of the liquefication and solidification of the metal halides are thus reduced, and the heat resistance of the polarizing glass 10 is improved.

More specifically, the thickness of the polarizing glass 10 is set to be smaller than 0.12 mm, and the conditions of the reduction step are controlled to control the thickness of each metal layers 12 and 14. The conditions are set such that the thickness of the metal halide layer 16 is in a range of 0.001 to 0.040 mm when the thickness of each of the metal layers 12 and 14 is 0.030 to 0.045 mm and the thickness of the metal halide layer 16 is in a range of 0.001 to 0.060 mm when the thickness of each of the metal layers 12 and 14 is 0.010 to 0.030 mm.

The polarizing glass 10 of the present embodiment is further described below by using examples and comparative examples, but the present embodiment is not limited to the following examples.

### Example 1

### [1. Manufacturing Step of Glass Substrate]

The polarizing glass 10 of Example 1 used a glass substate of SiO₂: 58.4, B₂O₃: 20.1, Al₂O₃: 6.7, AlF₃: 2.0, Na₂O: 8.8, NaCl: 1.7, Y₂O₃: 1.7, CuCl: 0.5, and SnO: 0.1 in terms of wt %.

SiO₂, H₃BO₃, Al(OH)₃, AlF₃, Na₂CO₃, NaCl, Y₂O₃, CuCl, and SnO were put into a five-liter platinum crucible as raw materials to be melted at about 1450° C., then poured into a graphite mold to be molded, and slowly cooled to room temperature to manufacture a glass substrate.

### [2. Deposition Step of Metal Halide Fine Particles]

This glass substrate was put into a heat-resistant mold, and subjected to heat treatment for six hours at 700° C. to deposit CuCl fine particles.

### [3. Preform Fabrication Step]

Then, the glass substrate was processed into a preform with a shape of 120×250×4 mm.

### [4. Drawing Step of Glass]

The preform was heated and drawn in a drawing furnace at temperature of about 620° C. to obtain a glass sheet with a width of about 18 mm and a thickness of about 0.5 mm.

### [5. Polished Product Fabrication Step]

This glass sheet was cut and polished on both sides to fabricate two types of both-side polished products that each had a 11 mm-square main flat face and that had thicknesses of 0.1 mm and 0.08 mm, respectively.

### [6. Reduction Step]

The two types of both-side polished products were subjected to heat treatment for seven hours at 440° C. in a hydrogen atmosphere to reduce drawn CuCl fine particles and deposit needle-shaped Cu metal fine particles, and the polarizing glasses 10 with polarizing characteristics were fabricated.

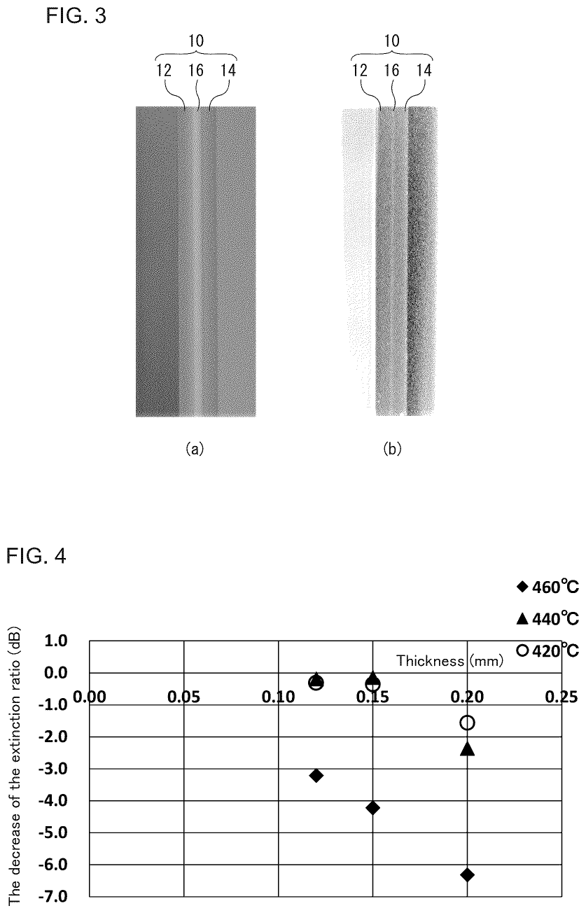

FIG. 3 is digital microscope photographs illustrating cross-sections of the polarizing glasses 10 of Example 1 after the reduction step, FIG. 3(a) illustrates an example of the cross-section of the polarizing glass 10 with the thickness of 0.1 mm, and FIG. 3(b) illustrates an example of the cross-section of the polarizing glass 10 with the thickness of 0.08 mm.

As illustrated in FIG. 3, the metal layers 12 and 14 formed on the front side and the back side of the polarizing glass 10 and the metal halide layer (unreduced layer) 16 formed between the metal layers 12 and 14 are observed as differences in colors. Note that portions on outer sides (left and right sides) of each polarizing glass 10 in FIG. 3 are backgrounds prepared to clarify the boundaries of the polarizing glass 10.

### Comparative Example 1

Four types of polarizing glasses that each had a 11 mm-square main flat face and that had thicknesses of 0.06 mm, 0.12 mm, 0.15 mm, and 0.20 mm, respectively were fabricated as Comparative Example 1 in a method similar to that in Example 1.

Table 1 is a table illustrating cross-sectional structures of the polarizing glasses 10 of Example 1 and the polarizing glasses of Comparative Example 1. Note that the metal layer thickness (one side), the metal layer thickness (both side total), and the unreduced layer thickness in Table 1 were obtained by cutting each sample into two and measuring the thickness of each of the metal layers (metal layers 12 and 14: Cu layers (portion colored in brown)) and the unreduced layer (metal halide layer 16 (uncolored portion)) in a thickness direction of a cut surface by using a digital microscope. Note that the units of numerical values in Table 1 are “mm”. Moreover, “*” in Table 1 indicates that the corresponding value is a value of Comparative Example 1.

TABLE 1

(Unit: mm)

| | Metal layer | Metal layer | |
|---|---|---|---|
| Total | thickness | thickness | Unreduced layer |
| thickness | (one side) | (both side total) | thickness |
| 0.20* | 0.038 | 0.076 | 0.124 |
| 0.15* | 0.038 | 0.076 | 0.074 |
| 0.12* | 0.038 | 0.076 | 0.044 |
| 0.10 | 0.038 | 0.076 | 0.024 |
| 0.08 | 0.038 | 0.076 | 0.004 |
| 0.06* | 0.030 | 0.060 | 0.000 |

### [Heat Resistance Test 1]

The extinction ratio of each of the samples of the polarizing glasses 10 of Example 1 and the polarizing glasses of Comparative Example 1 was measured at ordinary temperature, and the sample was then put in an electric furnace while being set on a SUS holder to stand, and subjected to heat treatment for two hours at each of temperatures of 420° C., 440° C., and 460° C.

After the heat treatment, the extinction ratio of each sample was measured, and the extinction ratios before and after the heat treatment were compared.

Table 2 is a table illustrating results of the comparison of the extinction ratios before and after the heat treatment at a measurement wavelength of 1650 nm for the polarizing glasses 10 of Example 1 and the polarizing glasses of Comparative Example 1. Note that the units of numerical values in Table 2 are “dB”. Moreover, “*” in Table 2 indicates that the corresponding value is a value of Comparative Example 1.

TABLE 2

| | 420° C. | | | 440° C. | | | 460° C. | | |
|---|---|---|---|---|---|---|---|---|---|
| Thickness | Before heat | After heat | Amount of | Before heat | After heat | Amount of | Before heat | After heat | Amount of |
| (mm) | treatment | treatment | decrease | treatment | treatment | decrease | treatment | treatment | decrease |
| 0.20* | 58.12 | 56.55 | −1.57 | 57.98 | 55.62 | −2.36 | 58.66 | 52.34 | −6.32 |
| 0.15* | 57.73 | 57.37 | −0.36 | 58.39 | 58.24 | −0.14 | 57.94 | 53.72 | −4.22 |
| 0.12* | 58.14 | 57.82 | −0.32 | 58.18 | 57.99 | −0.19 | 58.20 | 54.99 | −3.21 |
| 0.10 | 58.55 | 58.28 | −0.27 | 57.98 | 57.74 | −0.23 | 58.46 | 55.90 | −2.57 |
| 0.08 | 57.62 | 57.25 | −0.37 | 58.24 | 58.15 | −0.09 | 58.08 | 55.58 | −2.50 |
| 0.06* | 48.35 | 48.21 | −0.14 | 49.12 | 49.07 | −0.05 | 48.65 | 46.34 | −2.31 |

From Table 2, it is clarified that the smaller the thickness of the polarizing glass is, the smaller the decrease of the extinction ratio due to two hours of thermal treatment at 460° C. is.

Moreover, in the case of the thickness of 0.12 mm (Comparative Example 1), the decrease of the extinction ratio was −3.21 dB, and was about half the decrease of the extinction ratio in the case of the thickness of 0.20 mm (Comparative Example 1). Meanwhile, in the cases of the thickness of 0.10 mm (Example 1) and the thickness of 0.08 mm (Example 1), the decreases of the extinction ratio were −2.57 dB and −2.50 dB, respectively, and were suppressed to about 40% of the decrease of the extinction ratio in the case of thickness of 0.20 mm.

Moreover, in the cases of the thicknesses of 0.10 mm and 0.08 mm (Example 1), the decrease of the extinction ratio was −3.00 dB or less in all of the heat treatments of 420° C., 440° C., and 460° C., and it was clarified that the polarizing glasses had very high heat resistance.

Moreover, in the sample with the thickness of 0.06 mm (Comparative Example 1) without the metal halide layer 16 (unreduced layer), the thicknesses of the metal layers 12 and 14 were smaller than those in the samples of the other thicknesses, and the extinction ratio before the heat treatment was lower than those of the samples of the other thicknesses by about 10 dB. Accordingly, although the decrease of the extinction ratio after the heat treatment was suppressed to a low level, the extinction ratio after the heat treatment was lower than those of the other samples by an amount corresponding to the low initial extinction ratio.

It is found from above that the polarizing glass 10 can be made to have very high heat resistance while having a smaller thickness than the conventional polarizing glass by setting the thickness of the polarizing glass 10 smaller than 0.12 mm, setting the thickness of each of the metal layers 12 and 14 to 0.030 mm or larger, and setting the thickness of the metal halide layer 16 smaller than 0.044 mm.

Moreover, the following finding is obtained. As described above, when the thickness of each of the metal layers 12 and 14 is too large, the reduction time takes time and the boundary between the metal halide layer 16 and each of the metal layers 12 and 14 is unclear. When the thickness exceeds 0.045 mm, there is a risk that the metal halides remain also in the metal layers 12 and 14 near the boundaries with the metal halide layer 16. Accordingly, the thickness of each of the metal layers 12 and 14 is preferably set to 0.030 to 0.045 mm.

Moreover, the following finding is obtained. Assume a case where the total thickness of the polarizing glass is too small, the metal halide layer 16 is absent, and the thickness of each of the metal layers 12 and 14 that provide the extinction characteristics is small. In this case, a sufficient extinction ratio cannot be obtained. Accordingly, the thickness of the metal halide layer 16 is preferably set to 0.001 to 0.040 mm. Note that setting the thickness of the metal halide layer 16 to 0.001 to 0.030 mm is more preferable from the viewpoint of heat resistance.

### Example 2

### [1. Manufacturing Step of Glass Substrate]

The polarizing glass 10 of Example 2 used a glass substrate of SiO₂: 58.7, B₂O₃: 18.0, Al₂O₃: 2.0, Li₂O: 1.8, K₂O: 7.9, BaO: 3.4, TiO₂: 1.5, ZrO₂: 5.9, Ag: 0.3, and Cl: 0.5 in terms of wt %.

SiO₂, H₃BO₃, Al(OH)₃, Li₂CO₃, K₂CO₃, KNO₃, BaCO₃, TiO₂, ZrO₂, KCl, and AgCl were put into a five-liter platinum crucible as raw materials to be melted at about 1450° C., then poured into a graphite mold to be molded, and slowly cooled to room temperature to manufacture a glass substrate.

### [2. Deposition Step of Metal Halide Fine Particles]

This glass substrate was put into a heat-resistant mold, and subjected to heat treatment for six hours at 720° C. to deposit AgCl fine particles.

### [3. Preform Fabrication Step]

Then, the glass substrate was processed into a preform with a shape of 110×280×4 mm.

### [4. Drawing Step of Glass]

The preform was heated and drawn in a drawing furnace at temperature of about 640° C. to obtain a glass sheet with a width of about 17 mm and a thickness of about 0.6 mm.

### [5. Polished Product Fabrication Step]

This glass sheet was cut and polished on both sides to fabricate three types of both-side polished products that each had a 11 mm-square main flat face and that had thicknesses of 0.1 mm, 0.08 mm, and 0.06 mm, respectively.

### [6. Reduction Step]

The three types of both-side polished products were subjected to heat treatment for four hours at 440° C. in a hydrogen atmosphere to reduce drawn AgCl fine particles and deposit needle-shaped Ag metal fine particles, and the polarizing glasses 10 with polarizing characteristics were fabricated.

### Comparative Example 2

Four types of polarizing glasses that each had a 11 mm-square main flat face and that had thicknesses of 0.046 mm, 0.12 mm, 0.15 mm, and 0.20 mm, respectively were fabricated as Comparative Example 2 in a method similar to that in Example 2.

Table 3 is a table illustrating cross-sectional structures of the polarizing glasses 10 of Example 2 and the polarizing glasses of Comparative Example 2. Note that the metal layer thickness (one side), the metal layer thickness (both side total), and the unreduced layer thickness in Table 3 were obtained by cutting each sample into two and measuring the thickness of each of the metal layers (metal layers 12 and 14: Ag layers (portion colored in ocher)) and the unreduced layer (metal halide layer 16 (uncolored portion)) in a thickness direction of a cut surface by using an optical microscope. Note that the units of numerical values in Table 3 are “mm”. Moreover, “*” in Table 3 indicates that the corresponding value is a value of Comparative Example 2.

TABLE 3

(Unit: mm)

| | Metal layer | Metal layer | |
|---|---|---|---|
| Total | thickness | thickness | Unreduced layer |
| thickness | (one side) | (both side total) | thickness |
| 0.20* | 0.028 | 0.056 | 0.144 |
| 0.15* | 0.028 | 0.056 | 0.094 |
| 0.12* | 0.028 | 0.056 | 0.064 |
| 0.10 | 0.028 | 0.056 | 0.044 |
| 0.08 | 0.028 | 0.056 | 0.024 |
| 0.06 | 0.028 | 0.056 | 0.004 |
| 0.046* | 0.023 | 0.046 | 0.000 |

### [Heat Resistance Test 2]

The extinction ratio of each of the samples of the polarizing glasses 10 of Example 2 and the polarizing glasses of Comparative Example 2 was measured at ordinary temperature, and the sample was then put in an electric furnace while being set on a SUS holder to stand, and subjected to heat treatment for two hours at each of temperatures of 420° C., 440° C., and 460° C.

After the heat treatment, the extinction ratio of each sample was measured, and the extinction ratios before and after the heat treatment were compared.

Table 4 is a table illustrating results of the comparison of the extinction ratios before and after the heat treatment at a measurement wavelength of 1650 nm for the polarizing glasses 10 of Example 2 and the polarizing glasses of Comparative Example 2. Note that the units of numerical values in Table 4 are “dB”. Moreover, “*” in Table 4 indicates that the corresponding value is a value of Comparative Example 2.

TABLE 4

| | 420° C. | | | 440° C. | | | 460° C. | | |
|---|---|---|---|---|---|---|---|---|---|
| Thickness | Before heat | After heat | Amount of | Before heat | After heat | Amount of | Before heat | After heat | Amount of |
| (mm) | treatment | treatment | decrease | treatment | treatment | decrease | treatment | treatment | decrease |
| 0.20* | 57.12 | 55.20 | −1.92 | 56.83 | 54.02 | −2.81 | 55.87 | 48.75 | −7.12 |
| 0.15* | 56.21 | 55.58 | −0.63 | 57.62 | 56.33 | −1.29 | 56.48 | 51.61 | −4.87 |
| 0.12* | 56.45 | 56.03 | −0.42 | 56.29 | 55.78 | −0.51 | 57.25 | 53.90 | −3.35 |
| 0.10 | 56.69 | 56.14 | −0.55 | 57.41 | 57.09 | −0.32 | 56.15 | 53.53 | −2.62 |
| 0.08 | 57.83 | 57.48 | −0.35 | 56.73 | 56.55 | −0.18 | 57.38 | 55.44 | −1.94 |
| 0.06 | 56.32 | 56.13 | −0.19 | 57.16 | 57.09 | −0.07 | 56.41 | 54.59 | −1.82 |
| 0.046* | 43.52 | 43.44 | −0.08 | 44.62 | 44.58 | −0.04 | 42.74 | 41.05 | −1.69 |

From Table 4, it is clarified that the smaller the thickness of the polarizing glass is, the smaller the decrease of the extinction ratio due to two hours of thermal treatment at 460° C. is.

Moreover, in the cases of the thicknesses of 0.10 mm, 0.08 mm, and 0.06 mm (Example 2), the decrease of the extinction ratio was −2.62 dB or less in all of the heat treatments of 420° C., 440° C., and 460° C., and it was clarified that the polarizing glasses had very high heat resistance.

Moreover, in the sample with the thickness of 0.046 mm (Comparative Example 2) without the metal halide layer 16 (unreduced layer), the thicknesses of the metal layers 12 and 14 were smaller than those in the samples of the other thicknesses, and the extinction ratio before the heat treatment was lower than those of the samples of the other thicknesses by about 10 dB. Accordingly, although the decrease of the extinction ratio after the heat treatment was suppressed to a low level, the extinction ratio after the heat treatment was lower than those of the other samples by an amount corresponding to the low initial extinction ratio.

It is found from above that, in Example 2, the polarizing glass 10 can be made to have very high heat resistance while having a smaller thickness than the conventional polarizing glass by setting the thickness of the polarizing glass 10 smaller than 0.12 mm, setting the thickness of each of the metal layers 12 and 14 to 0.028 mm (≈0.030 mm) or smaller, and setting the thickness of the metal halide layer 16 smaller than 0.064 mm. Moreover, the following finding is obtained. As described above, when the thickness of each of the metal layers 12 and 14 is 0.010 mm or smaller, the thickness of each of the metal layers 12 and 14 that provide the polarizing characteristics is too small, and a sufficient extinction ratio cannot be obtained. Accordingly, the thickness of each of the metal layers 12 and 14 is preferably set to 0.010 to 0.030 mm.

Furthermore, the following finding is obtained. Assume a case where the total thickness of the polarizing glass is too small, the metal halide layer 16 is absent, and the thickness of each of the metal layers 12 and 14 that provide the extinction characteristics is small. In this case, a sufficient extinction ratio cannot be obtained. Accordingly, the thickness of the metal halide layer 16 is preferably set in a range of 0.001 to 0.060 mm. Note that setting the thickness of the metal halide layer 16 in a range of 0.001 to 0.050 mm is more preferable from the viewpoint of heat resistance.

### (Comparison of Example 1 (Comparative Example 1) and Example 2 (Comparative Example 2))

In comparison of the polarizing glass with the thickness of 0.06 mm in Comparative Example 1 (Tables 1 and 2) and the polarizing glass with the thickness of 0.046 mm in Comparative Example 2 (Tables 3 and 4), although the unreduced layer thickness was 0.000 mm in both polarizing glasses, the decrease of the extinction ratio due to two hours of heat treatment at 460° C. was −2.31 dB (Table 2) in the polarizing glass with the thickness of 0.06 mm in Comparative Example 1 while the decrease was −1.69 dB in the polarizing glass with the thickness of 0.046 mm in Comparative Example 2. Specifically, the decrease of the extinction ratio was more suppressed in the polarizing glass with the thickness of 0.046 mm in Comparative Example 2 than in the polarizing glass with the thickness of 0.06 mm in Comparative Example 1.

This is assumed to be due to the following reason. The thickness of each of the metal layers 12 and 14 was 0.030 mm in the polarizing glass with the thickness of 0.06 mm in Comparative Example 1, and was 0.023 mm in the polarizing glass with the thickness of 0.046 mm in Comparative Example 2. The polarizing glass with the thickness of 0.06 mm in Comparative Example 1 had thicker metal layers 12 and 14, and more insufficiently-reduced metal halides were present in the metal layers 12 and 14 as described above. Accordingly, the effects of the liquefication and solidification of the remaining metal halides after two hours of heat treatment at 460° C. caused more blunting of the shape of the needle-shaped metal fine particles, and the decrease of the extinction ratio was greater.

In comparison of the polarizing glass 10 with the thickness of 0.08 mm in Example 1 (Tables 1 and 2) and the polarizing glass 10 with the thickness of 0.06 mm in Example 2 (Tables 3 and 4), although the unreduced layer thickness was 0.004 mm in both polarizing glasses 10, the decrease of the extinction ratio due to two hours of heat treatment at 460° C. was −2.50 dB (Table 2) in the polarizing glass 10 with the thickness of 0.08 mm in Example 1 while the decrease was −1.82 dB in the polarizing glass 10 with the thickness of 0.06 mm in Example 2. Specifically, the decrease of the extinction ratio was more suppressed in the polarizing glass 10 with the thickness of 0.06 mm in Example 2 than in the polarizing glass 10 with the thickness of 0.08 mm in Example 1.

The reason for this is also assumed to be similar to the reason described in the comparison between the polarizing glass with the thickness of 0.06 mm in Comparative Example 1 and the polarizing glass with the thickness of 0.046 mm in Comparative Example 2, and is as follows. The polarizing glass 10 with the thickness of 0.08 mm in Example 1 had thicker metal layers 12 and 14, and more insufficiently-reduced metal halides were present in the metal layers 12 and 14. Accordingly, the effects of the liquefication and solidification of the remaining metal halides after two hours of heat treatment at 460° C. caused more blunting of the shape of the needle-shaped metal fine particles, and the decrease of the extinction ratio was greater.

Moreover, in comparison of the polarizing glass 10 with the thickness of 0.10 mm in Example 1 (Tables 1 and 2) and the polarizing glass 10 with the thickness of 0.10 mm in Example 2 (Tables 3 and 4), the decrease of the extinction ratio due to two hours of heat treatment at 460° C. was −2.57 dB (Table 2) in the polarizing glass 10 with the thickness of 0.10 mm in Example 1 in which the unreduced layer thickness was 0.024 mm while the decrease was −2.62 dB in the polarizing glass 10 with the thickness of 0.10 mm in Example 2 in which the unreduced layer thickness was 0.044 mm. Specifically, the decrease of the extinction ratio in the polarizing glass 10 with the thickness of 0.10 mm in Example 1 was at a similar level as that in the polarizing glass 10 with the thickness of 0.10 mm in Example 2.

The reason for this is also assumed to be similar to the aforementioned reason, and is as follows. The polarizing glass 10 with the thickness of 0.10 mm in Example 2 had thinner metal layers 12 and 14, and contains few insufficiently-reduced metal halides in the metal layers 12 and 14. Accordingly, the decrease of the extinction ratio after two hours of heat treatment at 460° C. is suppressed to a level lower than that in the polarizing glass 10 with the thickness of 0.10 mm in Example 1, and the overall decrease of the extinction ratio was at a similar level as that of the polarizing glass 10 with the thickness of 0.10 mm in Example 1 even though the unreduced layer thickness was larger by 0.020 mm.

The above description is provided for explaining the embodiments of the present invention, but the present invention should not be limited to the configurations of the aforementioned embodiments, but may be modified in various ways within the scope of the technical idea.

It should be noted that the embodiments disclosed herein should be considered to be exemplary and nonrestrictive in all respects. The scope of the present invention is specified not by the above description but by the scope of claims, and is intended to include all modifications within the meaning and scope equivalent to the scope of claims.

### REFERENCE SIGNS LIST

10 polarizing glass
10A polarizing element
10B polarizing element
12 metal layer
14 metal layer
16 metal halide layer
100 optical isolator
110 Faraday rotator
115 lens
115′ lens
116 optical fiber
117 light source
118 return light beam
118′ return light beam

1. A polarizing glass in which metal layers are formed from both surfaces toward inside and a metal halide layer containing metal halide fine particles is formed between the metal layers, the metal layers being layers in which many substantially needle-shaped metal fine particles are dispersed to be oriented parallel to one another, wherein
a total thickness of the polarizing glass is smaller than 0.12 mm,
a thickness of each of the metal layers is 0.030 to 0.045 mm, and
a thickness of the metal halide layer is 0.001 to 0.040 mm.

2. The polarizing glass according to claim 1, wherein the metal fine particles are copper or silver fine particles.

3. A polarizing glass in which metal layers are formed from both surfaces toward inside and a metal halide layer containing metal halide fine particles is formed between the metal layers, the metal layers being layers in which many substantially needle-shaped metal fine particles are dispersed to be oriented parallel to one another, wherein
a total thickness of the polarizing glass is smaller than 0.12 mm,
a thickness of each of the metal layers is 0.010 to 0.030 mm, and
a thickness of the metal halide layer is 0.001 to 0.060 mm.

4. The polarizing glass according to claim 3, wherein the metal fine particles are copper or silver fine particles.

5. An optical isolator comprising the polarizing glass according to claim 1.

6. An optical isolator comprising the polarizing glass according to claim 2.

7. An optical isolator comprising the polarizing glass according to claim 3.

8. An optical isolator comprising the polarizing glass according to claim 4.
